(19) United States
(12) Patent Application Publication
(10) Pub. No.: US 2011/0072696 A1
(43) Pub. Date: Mar. 31, 2011

(54) Channel Lighting Sign and Method of Fabricating the Same

(75) Inventor: Joseph Ungureanu, Sunnyside, NY (US)

(73) Assignee: FLEX A TRIM, Long Island City, NY (US)

(21) Appl. No.: 12/889,912

(22) Filed: Sep. 24, 2010

Related U.S. Application Data
(60) Provisional application No. 61/245,870, filed on Sep. 25, 2009.

(51) Int. Cl. G09F 13/18; B23P 19/00

(52) U.S. Cl. 40/546; 29/428

(57) ABSTRACT

A channel lighting sign is provided in which the side structure of the channel lighting sign can be constructed of a translucent polycarbonate material. The channel lighting sign includes a faceplate foamed of a translucent or transparent material, such as an acrylic plastic. The side structure is shaped to conform to perimeter contours of the shape of the faceplate. At least one mounting bracket is disposed on an inside surface of the side structure at a position near a front side of the side structure. The mounting bracket holds a mounting insert formed of a material that can easily and quickly bond with the faceplate material using a solvent or bonding agent.

### CROSS REFERENCE TO RELATED APPLICATION

The present application claims benefit of U.S. Provisional Application No. 61/245,870 filed on Sep. 25, 2009, the entire contents of which is incorporated herein by reference.

### FIELD OF THE INVENTION

The present invention relates generally to signage. More specifically, the present invention relates to a system and method for fabricating signage using channel lighting.

### BACKGROUND OF THE DISCLOSURE

Signage, whether a painted placard, neon sign, or channel light signs, help to advertise and attract perspective customers and patrons to an establishment. Channel light signage in particular has risen in popularity because of its low cost of maintenance and visibility at night.

Generally, channel light signs are made of a plurality of channel light letters spelling out a company name. Each individual channel light letter is formed of an aluminum side structure, commonly referred to as a can that is shaped in the outline of the particular letter. On the front face of the can, is mounted a translucent, or even transparent, face plate. The face plate is generally formed of an acrylic material such as Plexiglas™. Mounted inside the can is a light source, such as a florescent bulb, incandescent bulb, or a high output LED array. The illumination produced by the light sources is transmitted out of the can through the face plate, making the channel light letter highly visible at night.

The conventional channel light letter is constructed as shown in FIG. 1. The acrylic face plate 102 is bonded to an acrylic trim member 104 which runs along the perimeter of the face plate 102. The trim member 104 is disposed with a plurality of drill holes 106 into which screws 108 are inserted. The screws 108 are inserted through the trim member 104 and into matching holes 110 formed in the aluminum can 112, thus affixing the face plate 102 to the can 112. In addition, a light source 114 is attached to an aluminum backing 116 that is affixed to the back of the can 112 by means of screws, bolts or welds.

However, because the side structure, i.e. can 112, is formed of aluminum, the conventional channel lighting signs have a limited angle of visibility. The conventional channel lighting signs are highly visible when viewed from a position in front of the sign, but at night the opacity of the can 112 prevents visibility of the sign from any other position, such as an extreme right or left position. This lack of visibility at night from the sides can negatively impact a business's ability to be noticed by passing motorists, etc.

To overcome this lack of visibility, channel lighting constructed entirely of translucent plastic has been developed. In the all-plastic channel lighting the entire channel light letter is formed of a single piece of plastic molded over a pre-formed character mold. The process for creating the all-plastic channel lighting signs begins with the construction of a character mold, most commonly from metal. This form must be created for each character or logo. Once created the character mold is overlaid with a heated, or melted, plastic of the desired color and vacuum molded to the character mold. After the plastic has cooled, the character mold and plastic are separated.

While the all-plastic channel light letters are attractive and highly visible, this channel lighting technology does not lend itself to easy, inexpensive customization of the channel lighting shapes. In fact, the all-plastic channel lighting is readily available in a limited number of fonts, namely Helvetica and Ariel, and sizes. If a business needs letters in a different font to match a corporate trademark design, or non-alphanumeric shapes, such as a logo, the business would need to invest in production of molds for each of the non-standard shapes. Generally, if the business is a large entity having many storefronts needing the signage, the cost of producing the molds can be divided across the entire production of the many signs. However, for businesses that have only a small number of storefronts, producing the custom molds can be prohibitively expensive.

Additionally, the conventional all-plastic channel lighting is limited to having only one color plastic used in the character. This limits the ability to reproduce corporate logos and the like.

### SUMMARY OF THE DISCLOSURE

An objective of the present invention is to provide a channel lighting sign assembly that is inexpensive to produce, even in limited quantities, is easily customizable, and highly visible.

The channel light sign of the present invention includes a faceplate formed of a first material. The faceplate has a defined shape. The first material is a translucent or transparent material, such as an acrylic plastic. A side structure, formed of a second material that is chemically incompatible with the first material, is shaped to conform to perimeter contours of the defined shape of the faceplate. The material forming the side structure can be a polycarbonate plastic, aluminum, or other rigid material that can be cold shaped. At least one mounting bracket is disposed on an inside surface of the side structure at a position near a front side of the side structure. The channel light sign also includes at least one upper support member disposed substantially at the front side of the side structure and over hanging a cavity formed by the side structure. The upper support member and the at least one mounting bracket form a gap therebetween sized for accommodating a width of the faceplate.

Alternatively, the channel light sign of the present invention includes a faceplate having a defined shape and formed of a first material. The first material is a translucent or transparent material, such as an acrylic plastic. A side structure shaped to conform to perimeter contours of the defined shape of the faceplate is also provided with at least one mounting bracket disposed on an inside surface of the side structure at a position near a front side of the side structure. A mounting insert, adapted for mechanically mating with the at least one mounting bracket, is bonded to the faceplate. The mounting insert is formed of a material chemically compatible with the first material and capable of being bonded to the first material.

Moreover, the present invention discloses a method for fabricating a channel light sign. The method including the steps of: forming a faceplate having a defined shape, the faceplate being formed of a translucent or transparent first material; providing at least one mounting bracket disposed on a surface of a second material; cold shaping the second material into a side structure shaped to conform to perimeter contours of the defined shape of the faceplate, the side structure having the least one mounting bracket disposed on an inside surface of the side structure at a position near a front side of the side structure; forming a support member dimensioned for mechanically mating with the at least one mounting bracket; securing the faceplate to a support portion of the support member; and mating an insertion portion of the support member with the at least one mounting bracket

### BRIEF DESCRIPTION OF THE DRAWINGS

These and other features, aspects, and advantages of the present invention will become better understood with regard to the following description, appended claims, and accompanying drawings wherein:

FIG. 1 illustrates a cross-sectional view of a conventional channel light letter;

FIG. 2 illustrates a cross-sectional view of an embodiment of a channel light letter in accordance with the present invention;

FIG. 3 illustrates a cross-sectional view of another embodiment of a channel light letter in accordance with the present invention;

FIG. 4 illustrates a cross-sectional view of yet another embodiment of a channel light letter in accordance with the present invention; and

FIG. 5 illustrates a cross-sectional view of yet another embodiment of a channel light letter in accordance with the present invention.

### DETAILED DESCRIPTION OF DISCLOSURE

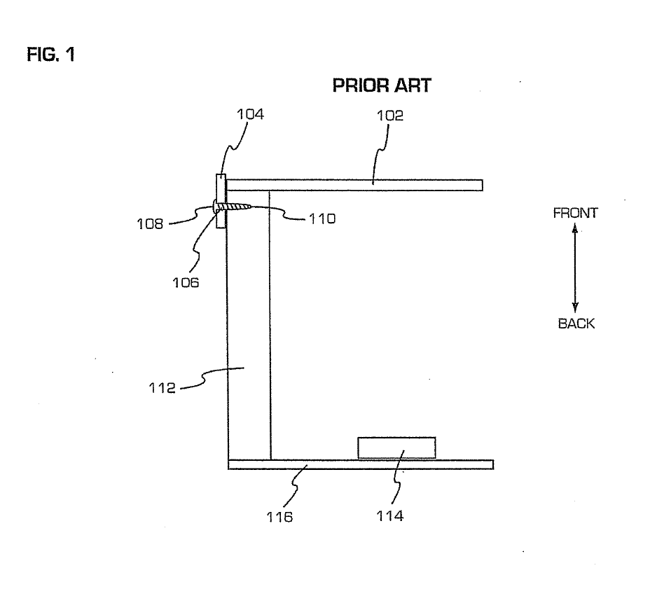

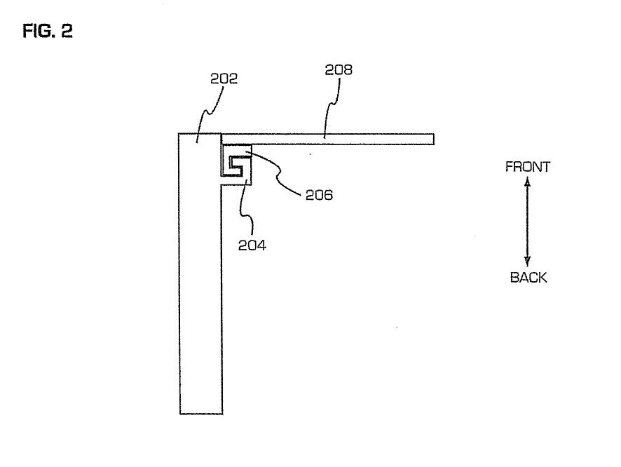

Referring to FIG. 2, an embodiment of a channel light sign in accordance with the present invention is shown in a profile view. As with the prior art shown in FIG. 1, the present embodiment includes a side structure, or can, 202 and a faceplate 208. However, in the present invention, the can 202 is not limited to only aluminum. Rather, the can 202 can be made of any rigid material that can be cold-shaped into the desired contours. Cold-shaping is the process of bending a sheet of a material into a desired contour without having to melt the material.

In one example, the material used for the can 202 is a polycarbonate such as Lexan™. The benefit of using a polycarbonate is that the material can be cold-shaped and can be translucent, thus allowing some of the light to radiate from the sides of the channel light sign. However, because polycarbonate plastics and acrylic plastics, used to form the faceplate, have different chemical structures, these plastics do not readily bond with each other using acetone-based solvents. Bonding agents used for creating a bond between a polycarbonate and an acrylic generally require hours of curing time and do not yield strong bonds.

In the present embodiment, shown in FIG. 1, the can 202 is provided with a mounting bracket 204 that is shaped as a hook or as an opened rectangle. The mounting bracket is dimensioned to accept a complimentarily shaped mounting insert 206. The mounting bracket 204 is formed of the same material as the can 202 and either bonded to the can 202 or formed integrally with the can 202. The mounting insert 206 and the mounting bracket 204 interconnect in a manner that creates a secure mechanical joint.

The mounting bracket 204 may be a single structure running along a perimeter of the can 202. In the alternative, the mounting bracket 204 may include a plurality of discrete structures distributed along the perimeter of the can 202. The benefit of having a plurality of mounting brackets 204 is that the mounting brackets 204 can be located at key points while allowing for a more intricately contoured can 202. On the other hand, the single mounting bracket 204 provides a uniform seal with the faceplate 208.

The mounting insert 206 is formed of a material that is chemically compatible with the material of the faceplate 208. In the context of the present invention, chemically compatible refers to the ability of two materials to form a strong bond with one another using an acetone-based solvent, or other appropriate bonding agent, such as CAB ResinBond™. Once the mounting insert 206 is mated with the mounting bracket 204, the faceplate 208 is bonded to an exposed surface of the mounting insert 206 using an appropriate bonding agent.

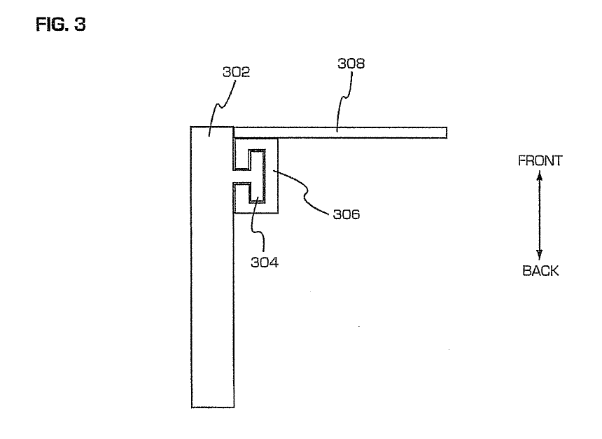

Referring to FIG. 3, the embodiment of the present invention shown is similar to the embodiment shown in FIG. 2. The present embodiment includes a can 302 that has a mounting bracket 304 disposed on an inner surface of the can 302. The mounting bracket 304 of the present embodiment differs from the mounting bracket 204 of the embodiment shown in FIG. 2 in shape only. Specifically, the present mounting bracket 304 has a “T” shape oriented with a 90° rotation. The mounting bracket 304 can be formed integrally with the can 302 or affixed to the surface of the can 302 after manufacture using any appropriate and well-known affixing means, such as bonding agents, rivets and screws.

A mounting insert 306, having an inverted “C” shape, is dimensioned to fit over the mounting bracket 304. As with the embodiment of FIG. 2, the present mounting bracket 306 is fabricated of a material that is chemically compatible with the material of the faceplate 308. The faceplate 308 is bonded to the surface of the mounting insert 306.

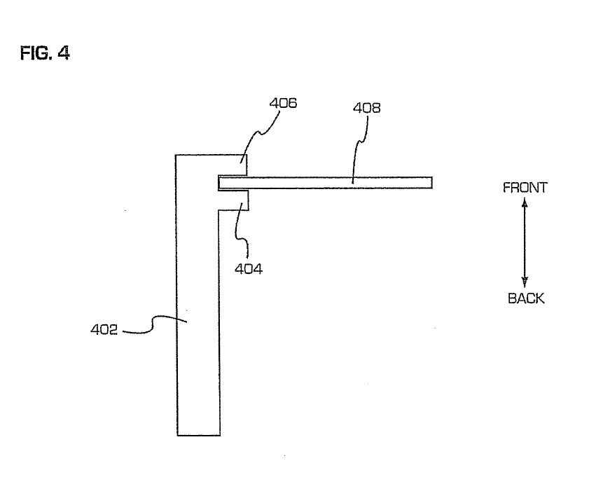

Another embodiment of the present invention is shown in FIG. 4. In the present embodiment, the can 402 has a mounting bracket 404 and an upper support member 406 disposed at a distance from the mounting bracket 404. The mounting bracket 404 and the upper support member 406 form a gap therebetween dimensioned to accommodate a faceplate 408.

In FIG. 4, the mounting bracket 404 and the upper support member 406 are shown extending outward from the surface of the can 402. However, in an alternative arrangement, the mounting bracket 404 and the upper support member 406 can be level with the surface of the can 402. In this case, a groove is formed between the mounting bracket 404 and the upper support member 406 to accommodate the faceplate 408.

In the embodiments shown in FIGS. 2 and 3, the can 202 or 302 can be formed into the desired contour before being fitted with the faceplate 208 or 308. However, in the embodiment shown in FIG. 4, the can 402 is shaped around the contours of the faceplate 408, such that the faceplate is locked into the gap formed between the mounting bracket 404 and the upper support member 406. Alternatively, the upper support member 406 may be disposed with a bevel edge (not shown) to facilitate insertion of the faceplate 408 into the gap after the can 402 has been shaped into the desired contour.

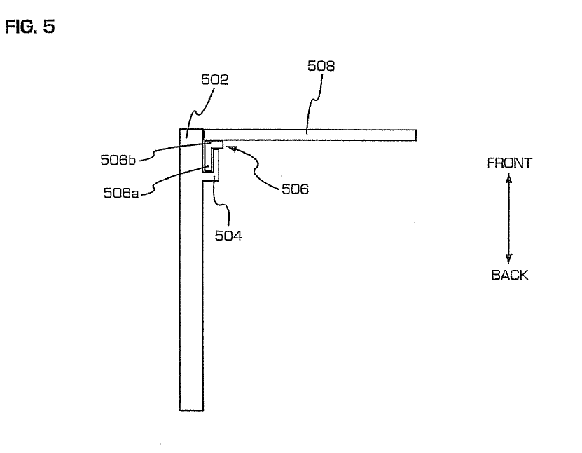

Yet another embodiment of the present invention is shown in FIG. 5. The present embodiment includes a side structure 502 formed of a first translucent plastic material and a faceplate 508 formed of a second translucent plastic material that is chemically incompatible with the first plastic material. Joining of the two materials is facilitated by a mounting bracket 504 and mounting insert 506. The mounting bracket 504 is formed on an inner front portion of the side structure 502, and preferably runs along the entire perimeter of the side structure 502. Preferably, the mounting bracket 504 is integrally formed with the material of the side structure 502.

The mounting insert 506 is formed of a material having a compatible chemical structure as the material of the faceplate 508. Additionally, the mounting insert 506 includes an insertion portion 506a dimensioned to form a mechanical joint with the mounting bracket 504. Ideally, the mounting insert 506 is dimensioned to run the entire perimeter of the side structure 502, as well. The mounting insert 506 also includes a support portion 506b formed at a right angle to the insertion portion 506a. The support structure is bonded to the bottom surface of the faceplate 508.

It is contemplated in the present invention that alternative shapes and configurations can be used for the mounting brackets and mounting inserts as would be apparent to one of ordinary skill in the art in light of the provided description of the present invention.

During maintenance of the channel lighting sign of the present invention, the entire structure, can and faceplate are removed as a unitary structure from a base member that supports the lighting system. The channel lighting sign of the present invention can be anchored to the base member using bolts, screws or other removable securing means as known in the art.

The present invention provides a structure for joining two chemically incompatible materials to form a channel light character. As such the materials used for the faceplate and side structure can be any combination of acrylates, polycarbonates, polyvinyls, flouroelastomers, urethanes, and metals. The materials appropriate for use in forming the side structures must be rigid and cold-shapeable. On the other hand, the faceplate materials must be translucent, and can be either rigid or flexible. While the present invention provides an advantage in joining two chemically incompatible materials as described above, the present invention can be used equally well for joining chemically compatible materials.

The material used for producing the side structure, or can, of the present invention is preferably formed into a continuous roll with the mounting bracket integrally formed. In such a case, channel lighting letters can be produced by feeding the material through a cold-shaping assembly line to be bent into the defined shapes in an automated process. In addition, because the material used for fabricating the side structure is cold-shapeable, the present invention allows for the inexpensive production of channel lighting signs of any shape or contour on demand. Consequently, the present invention is not limited to alphanumeric characters of limited font styles. Rather the present invention can be applied to the production of complex signage involving corporate logos, as well as non Latin alphabetic characters, such as Kanji, Hanzi, Cyrillic, Arabic, Greek, etc.

The present invention allows significant flexibility in design for modest cost, since a character mold does not need to be made. Further, the material used for the side structure may be of a first color, while the faceplate material can be a second color.

The described embodiments of the present invention are intended to be illustrative rather than restrictive, and are not intended to represent every embodiment of the present invention. Various modifications and variations can be made without departing from the spirit or scope of the invention as set forth in the following claims both literally and in equivalents recognized in law.

What is claimed is:

1. A channel light sign comprising:
a faceplate formed of a first material and having a defined shape, the first material being a translucent or transparent material;
a side structure shaped to conform to perimeter contours of the defined shape of the faceplate, the side structure being formed of a second material having a composition incompatible with the first material; and
at least one mounting bracket disposed on an inside surface of the side structure at a position near a front side of the side structure.

2. The channel light sign as in claim 1, further comprising a backplate mounted to a back side of the side structure, the backplate adapted for supporting an illumination system.

3. The channel light sign as in claim 1, further comprising at least one upper support member disposed substantially at the front side of the side structure and over hanging a cavity formed by the side structure, the upper support member and the at least one mounting bracket forming a gap therebetween sized for accommodating a width of the faceplate.

4. The channel light sign as in claim 1, further comprising a mounting insert adapted for mechanically mating with the at least one mounting bracket, the mounting insert being bonded to the faceplate, the mounting insert being formed of a material chemically compatible with the first material and capable of being bonded to the first material.

5. The channel light sign as in claim 4, wherein the bond between the faceplate and the mounting insert is accomplished with an acetone based acrylic bonding agent.

6. The channel light sign as in claim 1, wherein the first material is an acrylic plastic.

7. The channel light sign as in claim 1, wherein the side structure is formed of a polycarbonate plastic.

8. The channel light sign as in claim 1, wherein the side structure is formed of aluminum.

9. A channel light sign comprising:
a faceplate formed of a first material and having a defined shape, the first material being a translucent or transparent material;
a side structure shaped to conform to perimeter contours of the defined shape of the faceplate;
at least one mounting bracket disposed on an inside surface of the side structure at a position near a front side of the side structure; and
a mounting insert adapted for mechanically mating with the at least one mounting bracket, the mounting insert being bonded to the faceplate, the mounting insert being formed of a material chemically compatible with the first material and capable of being bonded to the first material.

10. The channel light sign as in claim 9, further comprising a backplate mounted to a back side of the side structure, the backplate adapted for supporting an illumination system.

11. The channel light sign as in claim 9, wherein the first material is an acrylic plastic.

12. The channel light sign as in claim 9, wherein the side structure is formed of a polycarbonate plastic.

13. The channel light sign as in claim 9, wherein the side structure is formed of aluminum.

14. The channel light sign as in claim 9, wherein the bond between the faceplate and the mounting insert is accomplished with an acetone based acrylic bonding agent.

15. A method for fabricating a channel light sign, the method comprising:
forming a faceplate having a defined shape, the faceplate being formed of a translucent or transparent first material;
providing at least one mounting bracket disposed on a surface of a second material;
cold shaping the second material into a side structure shaped to conform to perimeter contours of the defined shape of the faceplate, the side structure having the least one mounting bracket disposed on an inside surface of the side structure at a position near a front side of the side structure;
forming a support member dimensioned for mechanically mating with the at least one mounting bracket;
securing the faceplate to a support portion of the support member; and
mating an insertion portion of the support member with the at least one mounting bracket.

16. The method as in claim 15, further comprising attaching a backplate to a back side of the side structure, the backplate adapted for supporting an illumination system.

17. The method as in claim 15, further comprising providing at least one upper support member at an edge of the second material and extending perpendicular to the surface provided with the mounting bracket, the upper support member and the at least one mounting bracket forming a gap therebetween sized for accommodating a width of the faceplate.

18. The method as in claim 17, wherein the securing and cold shaping steps occur simultaneously, the second material being cold shaped along the perimeter contours of the faceplate with the faceplate being secured in the gap formed between the upper support member and the at least one mounting bracket.

19. The method as in claim 15, further comprising inserting, onto the at least one mounting bracket, a mounting insert adapted for mechanically mating with the at least one mounting bracket, the mounting insert being formed of a material chemically compatible with the first material and capable of being bonded to the first material.

20. The method as in claim 19, wherein the securing step includes bonding the faceplate to the mounting insert using an acetone based acrylic bonding agent.

21. The method as in claim 15, wherein the first material is an acrylic plastic.

22. The method as in claim 15, wherein the side structure is formed of a polycarbonate plastic.

23. The method as in claim 15, wherein the side structure is formed of aluminum.
